(19) United States
(12) Patent Application Publication
(10) Pub. No.: US 2019/0337614 A1
(43) Pub. Date: Nov. 7, 2019

(54) VERTICAL TAKEOFF AND LANDING AIRCRAFT

(71) Applicant: Uber Technologies, Inc., San Francisco, CA (US)

(72) Inventors: Ian Andreas Villa, San Francisco, CA (US); Mark Moore, San Francisco, CA (US); Adam Warmoth, San Francisco, CA (US); John Conway Badalamenti, San Francisco, CA (US); David Lane Josephson, Santa Cruz, CA (US)

(21) Appl. No.: 16/356,359

(22) Filed: Mar. 18, 2019

Related U.S. Application Data
(60) Provisional application No. 62/666,642, filed on May 3, 2018.

(51) Int. Cl. B64C 29/00; B64C 5/02; B64C 9/00; B64C 23/00

(52) U.S. Cl. CPC B64C 29/0025; B64C 5/02; B64C 3/16; B64C 23/00; B64C 2009/005; B64C 9/00

(57) ABSTRACT

An aircraft with a forward swept wing is configured to transition between vertical flight and forward flight. The aircraft includes propellers attached laterally along the wing. The propellers may be stacked propellers with two or more co-rotating rotors. The aircraft also includes booms attached along the wing and at each free end of the wing. The booms can include boom control effectors configured to direct airflow below a propeller. The aircraft includes one or more cruise propellers, configured to operate during forward flight to generate lift. The aircraft can also include control surfaces on the wings and tail that may tilt during takeoff and landing to yaw the vehicle.

### CROSS REFERENCE TO RELATED APPLICATIONS

This application claims the benefit of U.S. Provisional Application No. 62/666,642, filed May 3, 2018, which is incorporated by reference in its entirety.

### TECHNICAL FIELD

The described subject matter generally relates to the field of aerial transportation and, more particularly, to a vehicle for vertical takeoff and landing that can serve multiple purposes, including the transportation of passengers and cargo.

### BACKGROUND

Some existing vehicles in the emerging vertical takeoff and landing (VTOL) aircraft ecosystem rely on separate non-articulating rotors to provide vertical lift and forward thrust. However, this approach results in extra motor weight and aircraft drag since vertical lift rotors are ineffective during forward flight. Other existing aircrafts use a distributed set of tilting propulsors that rotate in the direction of flight to provide both vertical lift and forward thrust. While this approach reduces motor weight and aircraft drag, the articulating motor and propulsors result in increased design complexity with six to twelve tilting rotors required to provide the necessary lift and thrust.

### SUMMARY

In various embodiments, the above and other problems are addressed by a vertical takeoff and landing (VTOL) aircraft configured to transport passengers and/or cargo. The aircraft transitions between vertical flight using propellers to generate lift and forward flight using one or more wings to generate lift. In one embodiment, the aircraft includes a forward swept wing attached to a fuselage. The wing has two segments: a starboard segment and a port segment. An inboard boom is attached to a mid-region of each segment, and a wingtip boom is attached to each free end of the wing. Propellers, configured to generate lift during vertical flight, are attached to the inboard booms and/or the wingtip booms. Cruise propellers, configured to generate thrust during forward flight, may be attached to the wingtip booms approximately perpendicular to the lift propellers. The aircraft may also include lift propellers attached to a tail boom.

Some or all of the lift propellers may be stacked propellers. In one embodiment, a stacked propeller has two co-rotating propellers that generate lift during vertical flight while minimizing noise produced by the propellers. The inboard booms, wingtip booms, and/or the tail boom may include boom control effectors that are angled during one or more modes of operation for yaw control. The aircraft can also include control surfaces on the wings and tail that may tilt during takeoff and landing to yaw the vehicle.

In some embodiments, the aircraft and its components have different configurations corresponding to different phases of flight. During vertical flight (ascent and descent), the lift propellers rotate in a plane approximately parallel to the fuselage. The lift propellers may be canted 6 to 10 degrees toward the nose or tail of the aircraft. The boom control effectors may be angled to direct airflow below the stacked propeller and hinged control surfaces on the wings and tail can tilt to control rotation about the vertical axis (e.g., the yaw axis). As the aircraft transitions to a cruise configuration (e.g., forward flight), control surfaces and boom control effectors may return to a neutral position.

In a cruise configuration, the cruise propellers generate thrust and the wing generates lift. The lift propellers may stop rotating and retract into cavities in the aircraft to reduce drag. As the aircraft transitions to a descent configuration, the lift propellers can be redeployed from the cavities. The hinged control surfaces on the wings and/or tail are pitched downward to avoid interfering with an airflow of a stacked propeller. The boom control effectors may be angled to direct airflow below stacked propellers and reduce noise produced by the propellers.

### BRIEF DESCRIPTION OF THE DRAWINGS

FIG. 1A illustrates a top view of an aircraft with a forward swept wing, in accordance with one or more embodiments.

FIG. 1B illustrates a side view of an aircraft with a forward swept wing, in accordance with one or more embodiments.

FIG. 2A is a side view of a stacked propeller, in accordance with one or more embodiments.

FIG. 2B is a top view of a stacked propeller, in accordance with one or more embodiments.

FIG. 3 illustrates various configurations of a stacked propeller, in accordance with several embodiments.

FIG. 4A illustrates a configuration of a stacked propeller during a first mode of operation, in accordance with one or more embodiments.

FIG. 4B illustrates a configuration of a stacked propeller during a second mode of operation, in accordance with one or more embodiments.

FIG. 4C illustrates a configuration of a stacked propeller during a third mode of operation, in accordance with one or more embodiments.

FIG. 4D illustrates a configuration of a stacked propeller during a fourth mode of operation, in accordance with one or more embodiments.

FIG. 5 illustrates a front view of an aircraft during a cruise configuration, in accordance with one or more embodiments.

### DETAILED DESCRIPTION

The Figures and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

### 1.1 Aircraft Overview

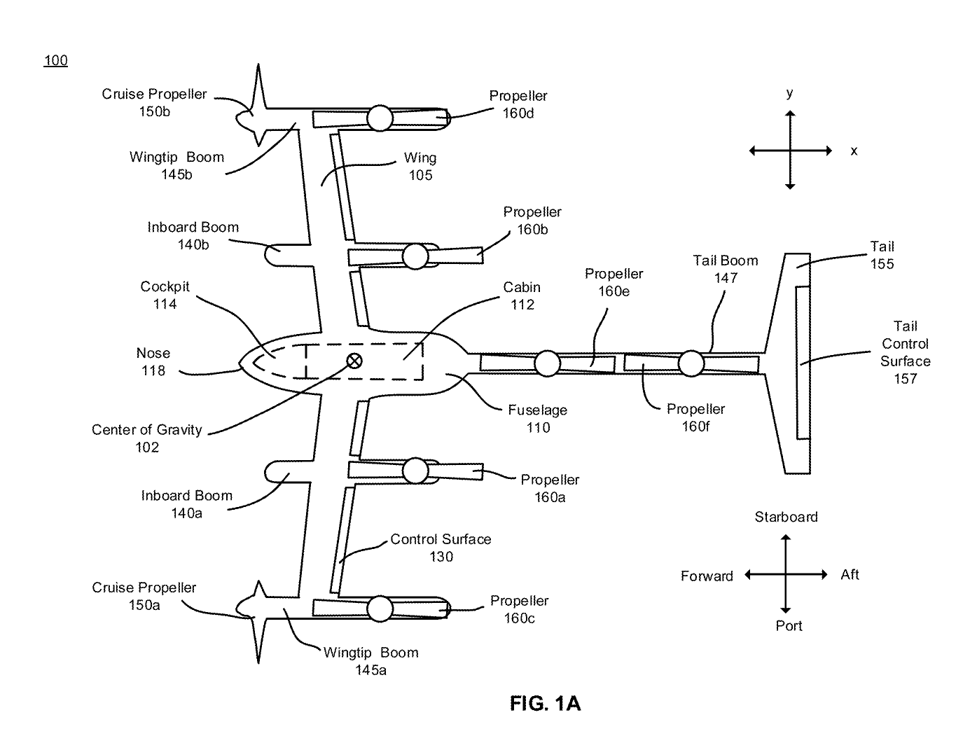

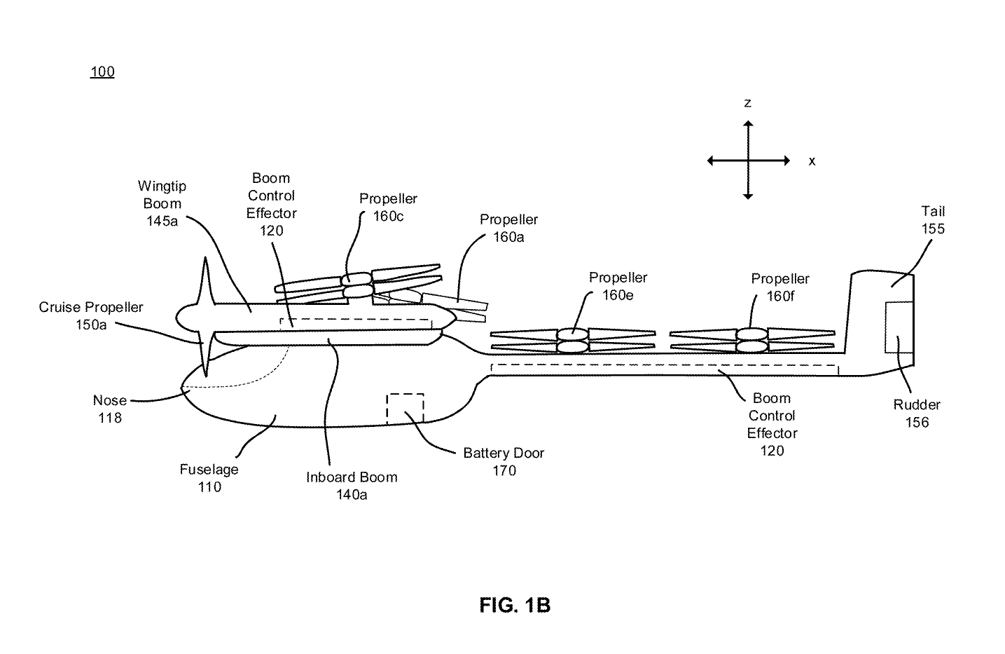

FIG. 1 is an illustration of a vertical takeoff and landing (VTOL) aircraft 100 configured to transport passengers and/or cargo. In the embodiment, the VTOL aircraft 100 is an aircraft that transitions between vertical flight and forward flight. As such, vertical flight relies on propellers to generate lift while forward flight primarily relies on a wing to generate lift. The aircraft 100 is configured to move with respect to three axes. In FIG. 1, a roll axis is collinear with the x-axis and a pitch axis is collinear with the y-axis. A yaw axis is collinear with the z-axis, where the z-axis is perpendicular to the x-axis and the y-axis (e.g., the z-axis extends from the page). The origin of the coordinate system is fixed to a center of gravity 102 of the aircraft 100 during one or more modes of operation.

The aircraft 100 includes an aerodynamic center and a center of thrust. The aerodynamic center is a point of an aircraft where the aerodynamic moment is constant. The aerodynamic moment is produced as a result of forces exerted on the aircraft 100 by the surrounding gas (e.g., air). The center of thrust is a point along the aircraft 100 where thrust is applied. The aircraft 100 includes components strategically designed and located so that the aerodynamic center, center of thrust, and/or center of gravity 102 can be approximately aligned (e.g., separated by a maximum distance of five feet) during various modes of operation. As such, the components of the aircraft 100, described below, are arranged so that the aircraft 100 is balanced during vertical and forward flight. In particular, components such as control surfaces 130, propellers 160, and a forward swept wing 105 function cooperatively to balance the aircraft 100 during different modes of operation, described in greater detail below.

The aircraft 100 includes a forward swept wing 105 extending from the body of a fuselage 110 and a tail region extending from the rear of the fuselage 110. In the embodiment of FIG. 1A-1B, the wing 105 has two segments, a starboard segment and a port segment, separated by a midline of the fuselage 110. The wing 105 has a forward swept configuration such that the forward most region of the wing 105 is located at a free end of the wing 105. Shown in FIG. 1A, the wing 105 protrudes outward (e.g., away from the fuselage 110) and forward (e.g., towards a nose 118) at approximately a 6 to 8 degree angle with respect to an axis parallel to the y-axis. In other embodiments, the wing 105 protrudes outward and forward from the fuselage 110 to inboard booms 140 at approximately an 8 to 10 degree angle and from the inboard booms 140 to the wingtip booms 145 and at approximately a 6 to 8 degree angle. In other embodiments, an angle of the wing 105 can have a range of 0 to 20 degrees such that each free end of the wing 105 is ahead (e.g., closer to the nose 118 along the x-axis) of the region of the wing 105 attached to the fuselage 110 in order to maintain aircraft 100 stability.

In one embodiment, the wing span (e.g., a length from a free end of the wing 105 on the starboard side to a free end of the wing 105 on the port side) is approximately 30 to 40 feet. As such, the wing 105 has an area large enough to provide lift during forward flight (e.g., the area may be approximately 120 to 150 square feet). Other embodiments may have different wingspans and/or areas.

Inboard booms (e.g., 140a, 140b) and wingtip booms (e.g., 145a, 145b) are attached to the wing 105 on each side. The inboard booms 140a and 140b may be collectively referred to herein as inboard booms 140, and wingtip booms 145a and 145b may be collectively referred to herein as wingtip booms 145. In some embodiments, the inboard booms (e.g., 140a, 140b) are attached at approximately a midpoint on each segment of the wing 105 and the wingtip booms 145 are attached to each free end of the wing 105. Cruise propellers (e.g., 150a, 150b) are also attached to each wingtip boom 145 approximately perpendicular to the fuselage 110. The cruise propellers 150a and 150b may be referred to collectively as cruise propellers 150.

The components described herein contribute to allowing for vertical and forward flight. In particular, the aircraft 100 relies on lift propellers (e.g., 160a, 160b, 160c, etc.), described in greater detail below, for vertical takeoff and landing. The aircraft 100 includes four wing propellers (e.g., 160a, 160b, 160c, 160d) and two tail propellers (e.g., 160e, 160f). The propellers 160a, 160b, 160c, and 160d may be oriented along the span (e.g., laterally) of the aircraft 100 and propellers 160e and 160f may be located along the tail of the aircraft 100 to increase efficiency and reduce noise.

### 1.2 Aircraft Fuselage

Shown in FIG. 1, the fuselage 110, located at the center of the wingspan, includes a cabin 112 configured to accommodate passengers and cargo and a cockpit 114 configured to accommodate a control panel and a pilot. The cabin 112 may include one or more seats for passengers. In one embodiment, the cabin 112 includes seating for up to four passengers. Seating may be arranged in two parallel rows of two seats such that one row of passengers faces the tail 155 of the aircraft 100 while the other row of passengers faces the nose 118 of the aircraft 100. Alternatively, the seating may be arranged in a single row with two sets of two seats, where the seats in each set of seats face opposite directions such that the passengers in the first and third seats face the tail 155 of the aircraft 100 while passengers in the second and fourth seats face the nose 118 of the aircraft 100. In other embodiments, all four seats face the nose 118 or tail 155 of the aircraft 100. In one embodiment, the passenger seating can be tiered such that one row of seats is elevated above the other row of seats to maximize space and provide a place for passengers to rest their feet. The arrangement of passenger seats may have alternate configurations in order to distribute the passenger weight in a specific manner such that the aircraft 100 is balanced during a mode of operation. In alternative embodiments, the cabin 112 can include a fewer or greater number of seats. Furthermore, the cabin 112 can include a view screen for providing information about the flight. For example, the view screen can include information such as estimated arrival time, altitude, speed, information about origin and destination locations, and/or communications from the pilot.

In one embodiment, the fuselage 110 is approximately 35 to 45 feet long in the y-direction (including a tail region, described below) and approximately 4 to 6 feet wide in the x-direction at a widest region which is approximately 5 to 7 feet from the nose 118 of the fuselage 110. The fuselage may be approximately 8 to 12 feet tall in the z-direction. As such, the fuselage 110 is able to accommodate four passenger seats and seating for a pilot. In one embodiment, the cockpit is approximately 3 to 4 feet long and approximately 2 to 4 feet wide for accommodating a pilot and a control panel. In alternative embodiments, the fuselage 110 and the cockpit 114 can have any suitable dimensions for transporting passengers and/or cargo.

The fuselage 110 also includes a tail region with a tail boom 147 and a tail 155. The tail boom 147 extends approximately 20 to 30 feet from the rear of the fuselage 110 to the tail 155 of the aircraft 100. In one embodiment, the tail 155 is a T-tail configured to provide stability to the aircraft 100. The T-tail is shaped and located in a position to provide lift to the aircraft 100 during a mode of operation. As such, the tail 155 can be referred to as a lifting tail. In the embodiment of FIGS. 1A-1B, the T-tail includes a tail plane mounted perpendicularly to the top of a fin. The fin can include a rudder 156, shown in FIG. 1B, that rotates about an axis parallel to the z-axis to control yaw motion of the aircraft 100. In one embodiment, the T-tail is approximately 3 to 6 feet tall from the base of the fin to the top of the tail plane and the tail plane is approximately 10 to 25 feet wide. The tail plane can include one or more tail control surfaces 157 located at the rear of the tail plane. As such, the tail 155, including the rudder 156 and tail control surface 157, can also contribute to adjusting the aerodynamic center towards the nose 118 of the fuselage 110 during one or more modes of operation, described in greater detail below. Furthermore, the tail 155 can include a navigation light to alert other aircrafts of a position and direction of the aircraft 100.

In some embodiments, the aircraft 100 is powered by one or more batteries. A battery pack can be located below the cabin 112 in the fuselage 110. The battery pack is separated from an inferior surface of the fuselage 110 to facilitate ventilation of the battery pack. The inferior surface of the fuselage 110 can also include a battery door 170, shown in FIG. 1B, to allow for removal of the battery pack. In alternative embodiments, the batteries can be placed above the fuselage 110 and integral to the wing 105. A charging port may be included at the nose 118 of the aircraft such that the battery can be attached to a charging station to restore electrical power to the battery via the charging port. The fuselage 110 may also include fixed or retractable landing gear attached to a surface of the fuselage 110 to facilitate landing of the aircraft 100 and allow the aircraft 100 to move short distances on the ground. Alternatively, the aircraft 100 may have landing skis protruding from the bottom of the fuselage 110 and include attachment points for wheels.

### 1.3 Control Surfaces

The aircraft 100 can include a variety of control surfaces configured to contribute to aircraft stability during one or more modes of operation. The control surfaces described below can be configured to position the aerodynamic center over a specified passenger seat (e.g., a rear passenger seat) so that it is coincident (or approximately coincident) with the center of gravity 102 during vertical flight. Shown in FIG. 1A, the aircraft 100 includes wing control surfaces 130 that span the trailing edge of the wing 105. The leading edge is the edge of wing 105 that first contacts air during forward flight and the trailing edge is the edge opposite to the leading edge of the wing 105. Each segment (e.g., port, starboard) of the wing 105 can have two wing control surfaces 130: a first wing control surface approximately 5 to 7 feet long between the fuselage 110 and an inboard boom (e.g., 140a, 140b) and a second control surface 130 approximately 3 to 5 feet long between an inboard boom (e.g., 140a, 140b) and a respective wingtip boom (e.g., 145a, 145b). The wing control surfaces 130 are approximately 6 to 12 inches wide in order to provide proper control and stability. In alternative embodiments, the aircraft 100 can have any number of wing control surfaces 130 with any suitable dimensions. The wing control surfaces 130 can be deployed at varying angles during aircraft operation to increase the lift generated by the wing 105 and/or to control the pitch of the aircraft 100. The wing control surfaces 130 are hinged such that they can rotate about a hinging axis parallel to the wing. For example, the wing control surfaces 130 may be pitched downward (e.g., below a plane parallel to the x-y plane) at an angle between 0 and 50 degrees during different modes of operation, described in greater detail below.

The aircraft 100 can also include control surfaces in other locations along the aircraft. In the embodiment of FIGS. 1A-1B, a rudder 156 and a tail control surface 157 operate as control surfaces to adjust the aerodynamic center of the aircraft 100 such that the aircraft 100 is dynamically stable in different modes of operation. Shown in FIG. 1B, the T-tail is tall enough so that the angle of the tail control surface 157 can be varied when a propeller 160 attached to the tail boom 147 induces a negative airflow angle of attack during transition between vertical and forward flight. Varying an angle of deployment of the tail control surface 157 may reduce negative effects of the airflow generated by the propellers on the tail region during transition. The tail control surface 157 and the rudder 156 may be angled 0 to 15 degrees in relation to a respective hinging axis in different modes of operation. In some modes of operation, the rudder 156 can operate in addition to or instead of boom control effectors, described below, for yaw control.

In some configurations, the aircraft 100 can include control surfaces on the bottom of each of the inboard booms 140, wingtip booms 145, and the tail boom 147 that tilt to yaw the aircraft 100. The control surfaces attached to the booms can deflect propeller flow to create control forces resulting in yaw and direct sideslip capabilities. The surfaces may be angled approximately 0 to 20 degrees during different modes of operation. In one embodiment, the control surfaces on the inboard booms 140, the wingtip booms 145, and/or the tail boom 147 are boom control effectors, described in greater detail below.

### 1.4 Propellers

The aircraft 100 includes a plurality of propellers to generate lift and thrust during different modes of operation. As described briefly above, the aircraft 100 includes cruise propellers 150a and 150b attached to wingtip booms 145a and 145b, respectively. The cruise propellers 150 provide forward thrust to the aircraft 100 during forward flight. A cruise propeller 150 can be attached to a wingtip boom 145 at approximately a zero-degree angle to a forward portion of a wingtip boom 145 such that blades of a cruise propeller 150 are approximately perpendicular to a wingtip boom 145. As such, the blades can rotate in a plane approximately parallel to the z-y plane during forward flight. In alternative embodiments, the blades can be angled such that they are offset (e.g., canted) in a plane parallel to the z-y plane. In the embodiment of FIGS. 1A-1B, a cruise propeller 150 is attached approximately 2 to 4 feet ahead of the leading edge of each free end of the wing 105. As such, the blades of a cruise propeller 150 are approximately 1 to 2 feet ahead of the front of the cockpit 114 such that they are misaligned with a pilot located at the front of the fuselage 110. In alternative embodiments, the cruise propellers 150 may be aligned with the pilot.

In the embodiment of FIGS. 1A-1B, each of the cruise propellers 150 has three blades, although a cruise propeller 150 may have fewer or more blades in other embodiments. The blades of the cruise propellers 150 narrow from a blade hub to a free end. The cruise propellers 150 may have a fixed pitch (e.g., the cruise propellers 150 are held at a fixed angle of attack). Alternatively, the pitch is variable such that the blades of the cruise propellers 150 can be partially rotated to control the blade pitch. Each cruise propeller 150 is approximately 8 to 10 feet in diameter to provide appropriate thrust to the aircraft 100. In other embodiments, the cruise propellers 150 can have any suitable dimensions for providing thrust during forward flight. Furthermore, each cruise propeller 150 can be driven by a motor in its respective wingtip boom 145 with a digital controller. As such, the cruise propellers 150 can be counter-rotating during forward flight. For example, cruise propeller 150a rotates in a clockwise direction and the cruise propeller 150b rotates in a counterclockwise direction during a mode of operation.

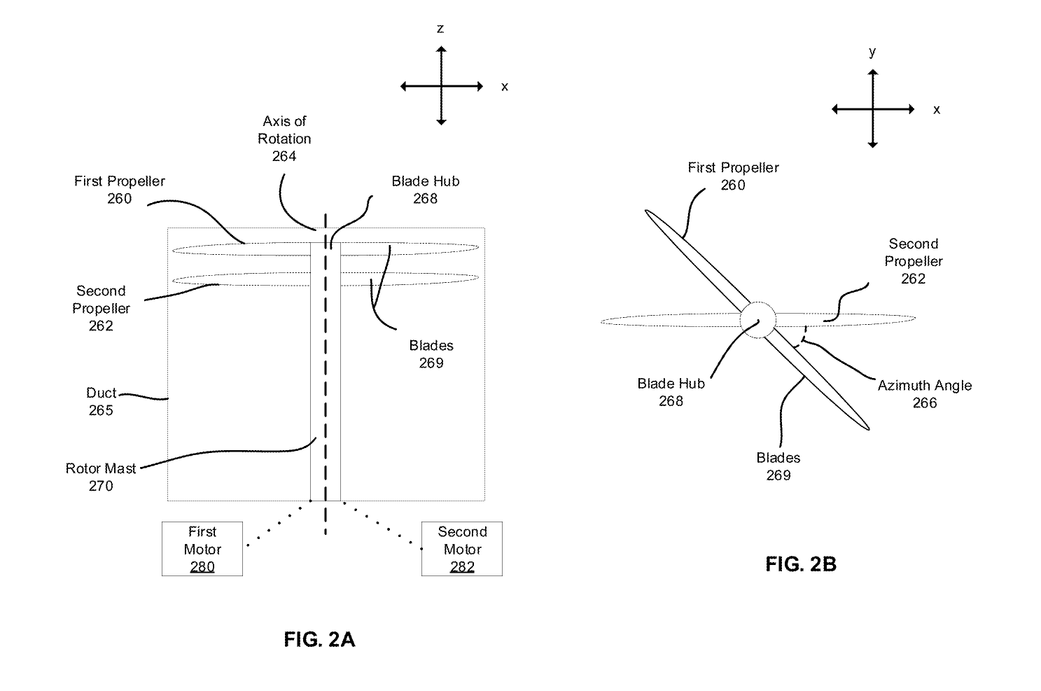

While the cruise propellers 150 are used during forward flight, the aircraft 100 relies on lift propellers during vertical flight. Shown in FIGS. 1A-1B, the aircraft 100 includes a plurality of lift propellers (e.g., 160a, 160b, 160c, 160d, 160e, 160f). The lift propellers may be collectively referred to as propellers 160. A lift propeller 160 can be a stacked propeller, where a stacked propeller includes two rotors configured to rotate about a blade hub, described in greater detail below in relation to FIG. 2. In some embodiments, all of the lift propellers 160 are stacked propellers. In other embodiments, only some or none of the lift propellers 160 are stacked propellers. For example, propellers 160a and 160c may be stacked propellers, while propellers 160b and 160d may be single rotor propellers.

The propellers 160a, 160b, 160c, and 160d are attached to the wing booms (e.g., 140, 145) and located behind the wing 105 in order to provide lift and stability to the aircraft 100. Locating a propeller (e.g., 160a, 160b, 160c, and 160d) behind the wing 105 allows for improved circulation over the wing and the propeller. As a result, a wing propeller (160a, 160b, 160c, and 160d) can provide a significant contribution to lift during vertical takeoff and landing. The location of the wing propellers (e.g., 160a, 160b, 160c, and 160d) also allows for alignment of the aerodynamic center, the center of thrust, and the center of gravity 102 of the aircraft during different modes of operation. The wing propellers can have a diameter appropriate for providing lift to the aircraft 100. In one embodiment, the propellers 160a, 160b, 160c, and 160d are approximately 8 to 10 feet in diameter.

The aircraft 100 also includes lift propellers 160e and 160f attached to the tail of the aircraft. Like the wing propellers (e.g., 160a, 160b, 160c, 160d), the tail propellers (e.g., 160e, 160f) can be located strategically along the tail boom 147 to contribute to alignment of the aerodynamic center, the center of thrust, and the center of gravity 102 during one or more modes of operation. In one embodiment, a diameter of the tail propellers 160e and 160f is approximately 6 to 8 feet for providing lift to the aircraft. The tail propellers 160e and 160f can any suitable diameter in alternative embodiments. The tail propellers 160e and 160f can have a fixed pitch and can be driven by an electric motor located in the tail boom 147. In alternative embodiments, a lift propeller can be located in any other position along the aircraft 100 and/or the aircraft 100 can include a fewer or greater number of lift propellers.

The orientation of the propellers 160 may minimize power required to transition between vertical flight and forward flight and prevent turbulent wake flow (e.g., turbulent air flow produced by a propeller) ingestion between propellers (e.g., the propellers 160 are located so that the airflow of one propeller does not negatively interfere with the airflow of another propeller). The arrangement of the propellers 160 may also allow for a more elliptically shaped lift and downwash airflow distribution during transition configurations to achieve lower induced drag, power, and noise. In one embodiment, the aircraft 100 has approximately 500 square feet of propeller area such that, an aircraft 100 with a weight of approximately 5,000 pounds has a disc loading is approximately 10 pounds per square foot. The disc loading is the average pressure change across an actuator disc, more specifically across a rotor or propeller. Power usage may be decreased when the disc loading is reduced, thus efficiency of an aircraft can be increased by reducing the disc loading. The combination and configuration of the propellers 160 of the aircraft 100 yields a disc loading that allows the aircraft 100 to generate enough lift to transport a large load using a reasonable amount of power without generating excessive noise.

The propellers 160 are configured to rotate in a plane approximately parallel to the x-y plane in order to generate lift. In some embodiments or during different modes of operation, the propellers 160 can be canted towards the nose 118 or a tail 155 of the aircraft 100 approximately 6 to 10 degrees, shown in FIG. 1B. During one or more modes of operation, propellers 160a and 160c can be angled outward from each boom (e.g., 140, 145) in a “V” shape at approximately a 30 to 45-degree angle for yaw control. In general, the propellers may be oriented to control aircraft 100 direction and/or noise.

FIGS. 2A and 2B illustrate a side view and a top view of a stacked propeller, according to an embodiment. The stacked propeller includes a first propeller 260 and a second propeller 262. The first propeller 260 and the second propeller 262 each include two blades 269 coupled to a blade hub 268. The blades 269 of the first propeller 260 and the second propeller 262 co-rotate about an axis of rotation 264. The first propeller 260 and the second propeller 262 can have a variable pitch.

The first propeller 260 can be coupled (e.g., mechanically, electrically) to a first motor 280 and the second propeller 262 can be coupled to a second motor 282 to enable independent control of each propeller. The first motor 280 or the second motor 282 can control both the first propeller 260 and the second propeller 262 in some embodiments. For instance, if the first motor 280 fails (e.g., battery dies), the second motor 282 can control the rotation of the first propeller 260 and the second propeller 262. A stacked propeller can also include a clutch which allows the first propeller 260 and the second propeller 262 to lock together to ensure an appropriate azimuth angle 266 during a mode of operation. A clutch allows for a stacked propeller to provide thrust from both the first propeller 260 and the second propeller 262, even in a case where one of the motors (e.g., first motor 280) fails and the other motor (e.g., second motor 282) controls the rotation of the first propeller 260 and the second propeller 262. In some embodiments, a stacked propeller can include a single motor and a controller with a clutch used to control the azimuth angle 266 that is used in a mode of operation, and in other embodiments a stacked propeller can include two motors with independent controllers and a clutch used in a case when one of the motors fails. The first motor 280 and the second motor 282 can also control the precise azimuth angle 266, shown in FIG. 2B, of the first propeller 260 relative to the second propeller 262, when the blades are stationary or in motion. The azimuth angle 266 depends on the mode of operation of the aircraft, described in greater detail below.

The co-rotating propellers (e.g. first propeller 260, second propeller 262) may be synchronized such that they rotate at the same speed to reduce the noise generated by the aircraft 100. The azimuth angle 266 is constant when the first propeller 260 and second propeller 262 are rotating at the same speed (e.g., during steady flight). The azimuth angle 266 can depend on the shape of the blade 269 and/or the mode of operation. For instance, a specified shape, such as the shape shown in FIG. 2B, can have an azimuth angle 266 of 5-15 degrees during different modes of operation.

The speed of the propellers may be adjusted based on the amount of thrust required for vertical flight and the amount of noise allowable in the geographic area in which the aircraft 100 is traveling. For example, the pilot might lower the speed of the aircraft 100, causing the aircraft 100 to climb more slowly, in areas in which a lower level of noise is desirable (e.g., residential areas). In one embodiment, the maximum speed of a free end of each of the blades 269 is 450 feet per second. This may keep the noise produced by the aircraft 100 below an acceptable threshold. In other embodiments, other maximum speeds may be acceptable (e.g., depending on the level of noise considered acceptable for the aircraft and/or aircraft environment, depending on the shape and size of the blades 269, etc.).

In one embodiment, a stacked propeller can be encapsulated in a duct 265. The duct 265 can surround the blades 269 and a rotor mast 270 to augment the flow over the first propeller 260 and/or the second propeller 262. The duct 265 can function to increase the thrust generated by a stacked propeller and/or adjust the pressure difference above and below the co-rotating propellers. The first propeller 260 and the second propeller 262 can be recessed within the duct 265, shown in FIG. 2A. In alternative embodiments, the first propeller 260 can be protruding from or flush with the duct 265 while the second propeller 262 is recessed within the duct 265. Similarly, the rotor mast 270 can be recessed within or protruding from the duct 265. In the embodiment of FIG. 2A, the duct 265 is a cylindrical body with a diameter slightly larger than the diameter of the first propeller 260 and the second propeller 262.

Co-rotating propellers may provide an advantage to single rotor propellers because they can produce less noise. Noise produced by propellers varies as an exponent of the tip speed of a propeller, thus, in order to reduce noise produced by a single rotor propeller, the aircraft speed is also reduced. A stacked propeller design also allows for flexibility of angles between the propellers which can be varied during different stages of flight functioning to increase the efficiency of the system. The speed and phase angle can be adjusted for each propeller on a stacked propeller, allowing for a more flexible and adaptable system. The stacked propellers can be stored during modes of operation where they are not necessary in order to reduce drag and improve efficiency.

The configuration of a stacked propeller can vary depending on the embodiment and requirements of the aircraft system and/or operation mode. In one embodiment, each co-rotating propeller (e.g., the first propeller 260, the second propeller 262) has the same blade shape and profile while in other embodiments, the first propeller 260 and the second propeller 262 have different dimensions and an offset phase of rotation. For example, the first propeller 260 and the second propeller 262 may have different camber and twist such that, when the propellers are azimuthally separated, a stacked propeller (e.g., 160a, 160b, 160c, etc.) is able to achieve optimal camber between the two surfaces. For example, in one embodiment, the diameter of the second propeller 262 is approximately 95% of the diameter of the first propeller 260. In other embodiments, the diameter of the first propeller 260 and the second propeller 262 are approximately equal.

In relation to material composition, a stacked propeller (e.g., 160a, 160b, 160c, etc.) can be made from of a single material or can be a composite material able to provide suitable physical properties for providing lift to the aircraft. The first propeller 260 and the second propeller 262 can be made from the same material or different materials. For example, the first propeller 260 and the second propeller 262 can be made from aluminum, or the first propeller 260 can be made from steel and the second propeller 262 can be made from titanium. The blade hub 268 can be made from the same or different material than the first propeller 260 and the second propeller 262. Alternatively, the components of the system (e.g., the first propeller 260, the second propeller 262, the blade hub 268) can be made from a metal, polymer, composite, or any combination of materials. The stacked propeller may also be exposed to extreme environmental conditions, such as wind, rain, hail, and/or extremely high or low temperatures. Thus, the material of the stacked propeller can be compatible with a variety of external conditions.

In relation to mechanical properties, the material of the first propeller 260 and the second propeller 262 can have a compressive strength, a shear strength, a tensile strength, a strength in bending, an elastic modulus, a hardness, a derivative of the above mechanical properties and/or other properties that enable the propeller to provide vertical lift to the aircraft. The first propeller 260 and the second propeller 262 may experience extreme forces during operation including thrust bending, centrifugal and aerodynamic twisting, torque bending and vibrations. The material of the first propeller 260 and the second propeller 262 can have a strength and rigidity that allows the propellers to retain their shape under forces exerted on the propellers during various modes of operation. In one embodiment, the first propeller 260 and/or the second propeller 262 are composed of a rigid composite. Additionally, the edges or tips of the blades 269 can be lined with a metal to increase strength and rigidity.

In one embodiment or during a certain mode of operation, the first propeller 260 and the second propeller 262 may co-rotate in a counter clockwise direction. In a different mode of operation, the first propeller 260 and the second propeller 262 can co-rotate in a clockwise direction. In the embodiment of FIGS. 1A-1B, stacked propellers on opposite sides of the aircraft can rotate in opposite directions in different modes of operation. For example, the propellers 160a and 160c can rotate in a clockwise direction and the propellers 160b and 160d can rotate in a counter clockwise direction. Propellers 160e and 160f can also rotate in opposite directions, or they can rotate in the same direction. For example, the propellers 160e and 160f can both rotate in a clockwise direction during a mode of operation. The rotational direction of a stacked propeller may depend on the mode of operation. In other embodiments, different combinations of propellers 160 may be rotating in different directions during different modes of operation. For example propellers 160a may be rotating clockwise and 160b may be rotating counter clockwise while propellers 160c, 160d, 160e, and 160f are stationary. The above description is not exclusive of the possible combinations of directions of rotation for each stacked propeller. The examples are used for illustration purposes.

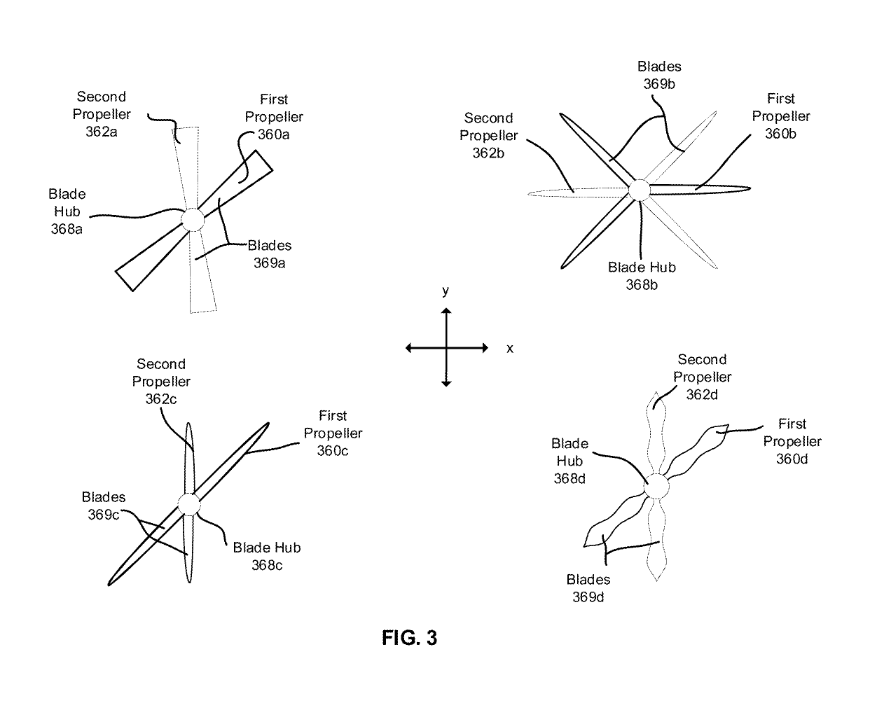

FIG. 3 illustrates a first embodiment (top left), a second embodiment (top right), a third embodiment (bottom left), and a fourth embodiment (bottom right), of a stacked propeller. A first embodiment (top left) shows a top view of a stacked propeller including a first propeller 360a and a second propeller 362a with angular blades 369a. The first propeller 360a and the second propeller 362a each includes two blades 369a. The width of the blades 369a is narrower at the blade hub 368a than at the free end of the blades 369a. A second embodiment (top right) of FIG. 3 includes a first propeller 360b with three blades 369b and a second propeller 362b with three blades 369b. The blades 369b are wider at the blade hub 368b than at the free ends of the blades 369b. The free ends of the blades 369b are round. A third embodiment (bottom left) of FIG. 3 shows a schematic including a first propeller 360b and a second propeller 362b each including two blades 369b coupled to a blade hub 368c. The blades 369b of the propellers are wider at the blade hub 368c than at the free end. The diameter of the second propeller 362c is smaller than the diameter of the first propeller 360c. A fourth embodiment (bottom right) of FIG. 3 includes a propeller with a first propeller 360d and a second propeller 362d, each including two blades 369d coupled to a blade hub 368d. The blades 369d are curved along the length from the blade hub 368d to the free end of the blades 369d.

FIG. 3 shows several embodiments and combinations of embodiments of a stacked propeller. Alternatively, a stacked propeller can have different characteristics (e.g., shape, orientation, size) and different combination of embodiments to satisfy the design constraints (e.g., load capacity, manufacturing limitations) of an aircraft. A stacked propeller 160 can also have a different number of propellers each with a different number of blades to improve aircraft efficiency or reduce noise. In one embodiment, a stacked propeller includes a different blade pitch and different twist distributions on each set of blades. A first propeller (e.g., a top propeller) may have a lower pitch to induce an airflow, while a second propeller (e.g, a propeller below a top propeller) can have a higher pitch to accelerate the airflow. The twist distribution can be configured to stabilize an interaction of a tip vortex (e.g., vortex produced by the tip speed of the upper blade) with a lower blade in order to produce optimal thrust.

### 1.5 Booms and Boom Control Effectors

In the embodiment of FIGS. 1A-1B, the aircraft 100 includes five booms: two inboard booms 140, two wingtip booms 145, and a tail boom 147. In general, booms contain ancillary items such as fuel tanks, but they can also be used for providing structural support to an aircraft. In one embodiment, a boom can include boom control effectors that facilitate different modes of operation of an aircraft. In the embodiment of FIGS. 1A-1B, a propeller 160 can be coupled to a boom (e.g., 140, 145, 147) such that a propeller 160 directs airflow past a boom during a mode of operation. Shown in FIGS. 1A-1B, propellers 160a and 160b are attached to inboard booms 140a and 140b, respectively, and propellers 160c and 160d are attached to wingtip booms 145a and 145b, respectively. Propellers 160e and 160f are attached to the tail boom 147. In alternative embodiments, a single rotor propeller (e.g., a cruise propeller 150) can be attached to a boom.

The booms (e.g., inboard boom 140, wingtip boom 145) can be hollow and can be used to store aircraft components useful for operation. For instance, a boom can include electric motors and batteries to power a propeller 160 or other aircraft components. In one embodiment, a battery is located inside an inboard boom 140 and spans the length of an inboard boom 140. In other embodiments, a battery can be located at either end of an inboard boom 140 or a wingtip boom 145 to act as a counterweight to help maintain the balance and alignment of aircraft 100. The battery can also be placed in a location inside an inboard boom 140 or a wingtip boom 145 to minimize aero elastic and whirl flutter resonance during a mode of operation. In alternative embodiments, the battery can be located in another position along the aircraft 100. A battery door can be located on the bottom of a boom to allow for removal of the battery powering a propeller 160 or another aircraft component.

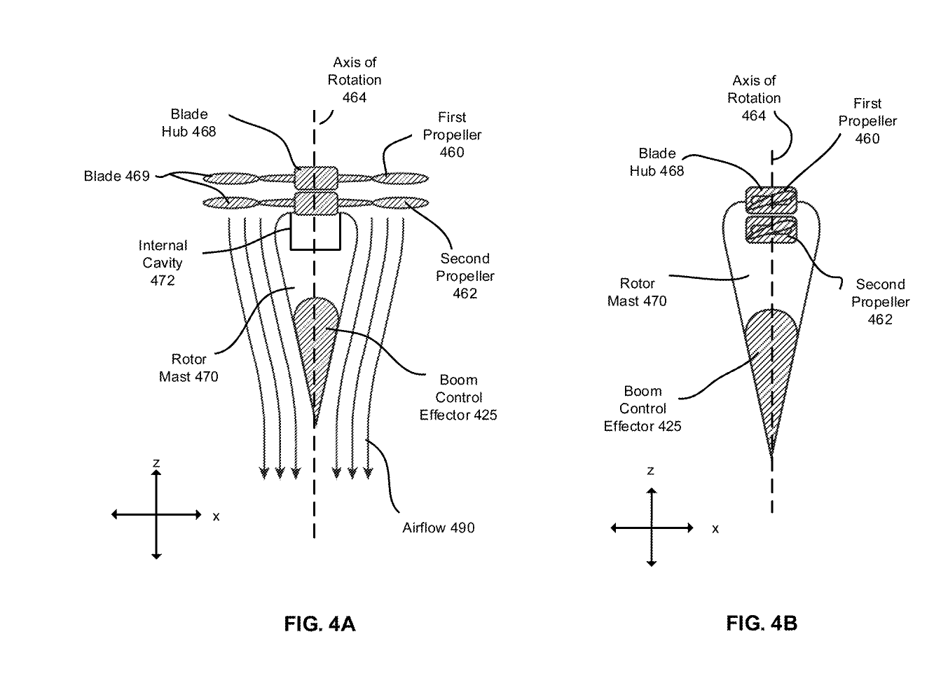

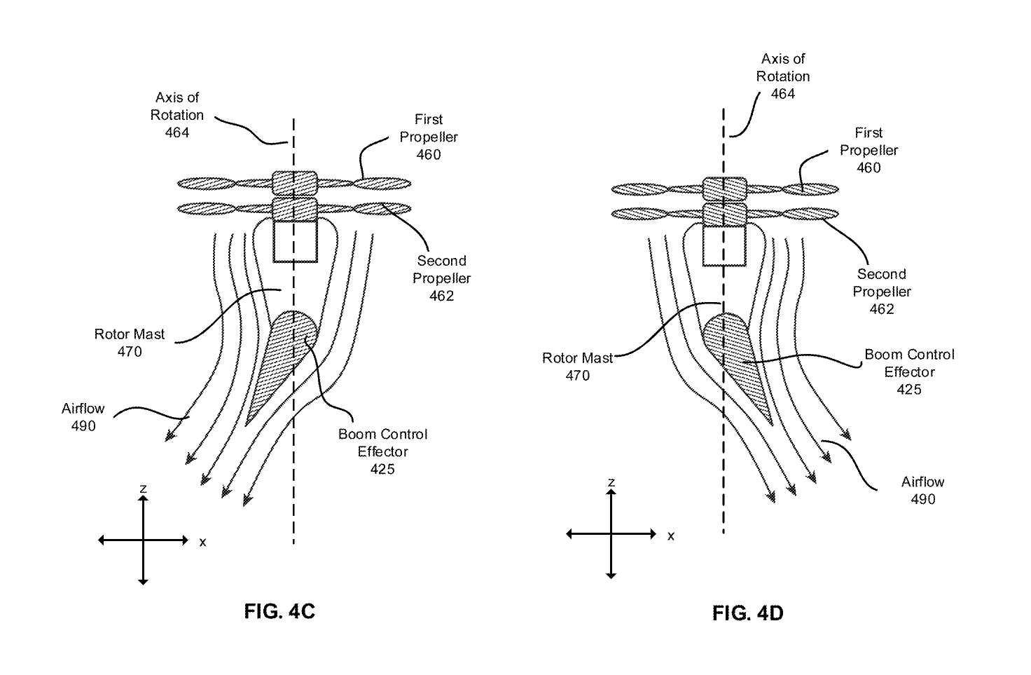

In an embodiment where an inboard boom 140 and/or a wingtip boom 145 is hollow, the boom can be used as a resonator to alter the noise signature of the aircraft 100 during one or more modes of operation. A Helmholtz resonator is a container of gas, such as air, with an open hole. A resonator can be tuned to the frequency of a propeller such that the noise resulting from the airflow over a propeller coupled to the boom (e.g. inboard boom 140, wingtip boom 145) is reduced. Sound produced as a result of pressure fluctuations generated by a propeller can be modified by the presence of a tuned volume inside a boom. Tuning the volume can permit acoustic and aerodynamic modification such that the radiated sound emitted by a propeller coupled to a boom is reduced. In one embodiment, a boom (an inboard boom 140, a wingtip boom 145) has an appropriate volume of air relative to the size of a propeller to act as a resonator. In a mode of operation when the stacked propellers are deployed (i.e. vertical flight), an internal cavity 472, as described below in relation to FIG. 4A, can function as the entrance for airflow into the resonator. A portion of the air flow over the stacked propeller can flow into the boom (e.g., inboard boom 140, wingtip boom 145) via the internal cavity 472 and the frequency can be tuned to reduce the noise produced by the propeller.

In the embodiment of FIGS. 1A-1B, the aircraft 100 includes propellers 160 coupled to the booms. As such, during vertical flight the propellers 160 blow air past the booms to generate lift. A cross sectional view of an embodiment of a boom (e.g., a wingtip boom 145, an inboard boom 140) is shown by FIGS. 4A-4D. FIGS. 4A-4D demonstrate different modes of operation of a stacked propeller and a boom control effector 425. The schematic includes a first propeller 460, a second propeller 462, a blade hub 468, blades 469, a rotor mast 470, and an internal cavity 472. FIG. 4A shows a schematic where the first propeller 460 and the second propeller 462 are coupled to a rotor mast 470. In one embodiment, the rotor mast 470 is a boom (e.g. 140, 145, 147). As such, a boom can be configured to have a surface profile that matches the blade profile of the first propeller 460. This enables a conformal surface fit between the first propeller 260 and the boom (i.e., the rotor mast 470) to minimize drag and flow separation.

A boom control effector 425 can be configured to rotate about an axis perpendicular to an axis of rotation 464. A boom control effector can be a single effector as described by FIGS. 4A-4D or a split effector, described in greater detail below. The boom control effector 425 is configured to direct the airflow from a propeller. FIG. 4A illustrates the boom control effector 425 during a mode of operation, such as a vertical takeoff configuration. The boom control effector 425 is in a neutral position in FIG. 4A. An airflow 490 over the propellers (e.g., first propeller 460, second propeller 462) is not separated from the surface of the boom and is directed in a negative z-direction. FIG. 4B illustrates a mode of operation, such as a cruise configuration, where the propellers (e.g., first propeller 460, second propeller 462) are recessed within an internal cavity 472. When the propellers (e.g., first propeller 460, second propeller 462) are recessed within the cavity 472, the boom control effector 425 may not be in operation (e.g., the boom control effector remains in a neutral position).

FIGS. 4C-4D illustrate two other modes of operation of a boom control effector, according to an embodiment. FIGS. 4C-4D show a boom control effector 425 rotated about an axis perpendicular to an axis of rotation 464 (e.g., an axis extending from the page). The angle of the boom control effector 425 directs the downstream airflow 490 in a direction offset from an axis parallel to the z-axis (i.e. to the left or right) of the boom during different modes of operation. The angle may range from 0 degrees (i.e. neutral position) to a 30 degree offset. The angle of the boom control effector 425 can be manually controlled or automated during different modes of operation. The angle can be held constant during a mode of operation or may change according to environmental conditions. Alternatively, the boom control effector 425 can be configured to continuously oscillate about an axis perpendicular to the axis of rotation 464. The oscillation frequency can be tuned to align with the frequency of a boom that functions as a resonator, as described above. In alternative embodiments, the boom control effector 425 can be configured to direct the airflow 490 in another direction. The movement of the boom control effector 425 is configured to control the cross wind of the propeller and mitigate the acoustic signature of the propeller. The boom control effector 425 provides an advantage as it can allow for control the direction of the airflow 490, which may result in a significant reduction in noise produced by the propeller. It may also allow for enhanced yaw control of an aircraft. The boom control effector 425 can also improve efficiency and reduce power consumed by the aircraft 100 by realigning the airflow.

In FIGS. 4A-4D, the boom control effector 425 has a teardrop shape. In other embodiments, the boom control effector 425 can have another shape suitable for mitigating noise and directing airflow. For instance, the boom control effector 425 can have a split configuration such that during a mode of operation, the boom control effector 425 has multiple longitudinal surfaces that can control airflow direction. The split configuration can be configured to allow the boom to act as a resonator, as described above. In one embodiment, boom control effector 425 and a corresponding boom (e.g., wingtip boom 145, inboard boom 140) have a non-circular cross section to reduce undesired effects (e.g., aeroelastic and whirl flutter) of aerodynamic forces on the aircraft 100. In particular, the wingtip booms 145 can have a non-circular cross section to reduce the effect of aerodynamic forces, including forces resulting from a cruise propeller 150, on the aircraft 100. The boom control effector 425 can also have a rectangular end region coupled to the rotor mast 470 and a pointed or rounded free end region. The shape of the boom control effector 425 can vary depending on design considerations (e.g., size of the propellers, location of the propellers, aircraft load capacity, etc.) of the aircraft.

In relation to material composition, boom control effector 425 can be made from of a single material or can be a composite material able to provide suitable physical properties for controlling the direction of airflow behind a propeller. The boom control effector 425 can be made from the same material or a different material than the rotor mast 470. The boom control effector 425 may also be exposed to extreme environmental conditions, such as wind, rain, hail, and/or extremely high or low temperatures. Thus, the material of the boom control effector 425 can be compatible with a variety of external conditions.

In relation to mechanical properties, the material of the boom control effector 425 can have a compressive strength, a shear strength, a tensile strength, a strength in bending, an elastic modulus, a hardness, a derivative of the above mechanical properties and/or other properties that enable the boom control effector 425 to direct the airflow 490 behind or below a propeller. The boom control effector 425 may experience extreme forces during operation including thrust bending, centrifugal and aerodynamic twisting, torque bending and vibrations. The material of the boom control effector 425 can have a strength that allows the boom control effector 425 to retain its shape under forces exerted on the boom control effector 425 during various modes of operation.

As described above, a boom control effector is included in the VTOL aircraft 100 to direct airflow behind or below a stacked propeller 160. A side view of the aircraft 100 illustrating the wingtip boom 145a and the tail boom 147 with a boom control effector 120 is shown in FIG. 1B. The boom control effector 120 attached to the wingtip boom 145a is configured to direct airflow from the propeller 160c. As such, the length of the boom control effector 120 is approximately equal to the diameter of the propeller 160c. The boom control effector 120 attached to the tail boom 147 extends along the longitudinal surface of the tail boom 147 and is positioned below propellers 160e and 160f. In one embodiment, the combined diameter of the propellers is approximately equal to the length of the boom control effector 120. In alternative embodiments, the combined diameter of the propellers 160e and 160f can be larger or smaller than the length of the boom control effector 120. Furthermore, in alternative embodiments, the aircraft tail boom 147 can have more than one boom effector 120 (e.g., a boom control effector corresponding to each propeller). Although not shown in FIG. 1B, inboard booms 140 and wingtip booms 145b can also include a boom control effector 120. In alternative embodiments, a boom control effector can be included in any aircraft that includes rotors or propellers, such as a helicopter, and/or can direct airflow below a single rotor propeller.

### 1.6 Modes of Operation

The aircraft 100 can have different configurations in different modes of operation. FIGS. 1A-1B illustrate the aircraft 100 in a first mode of operation (e.g., vertical flight). During vertical flight (i.e. takeoff and landing), the propellers 160 may be rotating at a constant speed to generate thrust. The propellers 160 may be rotating in a plane approximately parallel to the x-y plane, or may be canted towards the nose 118 or tail 155 of the aircraft 100 as shown in FIG. 1B. The control surfaces (e.g., control surface 130, rudder 156, tail control surface 157) may be angled between 0 and 40 degrees such that the aircraft is stable during operation. A boom control effector attached to an inboard boom 140, a wingtip boom 145 and/or a tail boom 147 can be angled approximately 0 to 20 degrees to direct airflow below a propeller 160. The boom control effectors and the control surfaces may be controlled independently such that each surface can have a different angle of operation. The cruise propellers 150 may be stationary during vertical flight.

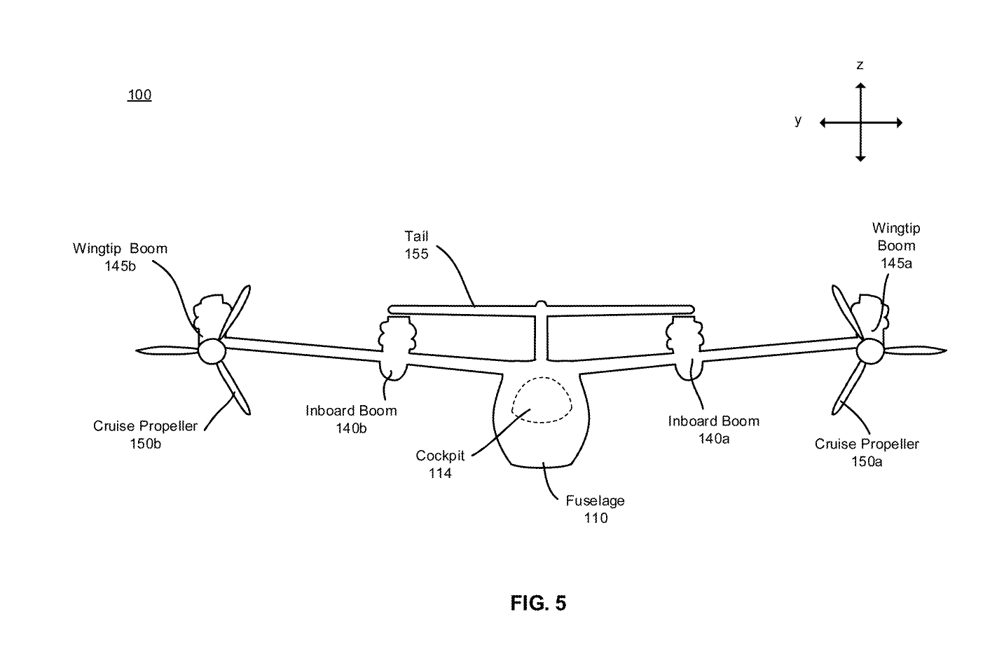

As the aircraft 100 transitions from vertical flight shown in FIGS. 1A-1B to forward flight (e.g., cruise), the propellers 160 can be retracted along an axis of rotation and recessed within an internal cavity of the aircraft. As described above, FIG. 4A shows a configuration of one embodiment of a stacked propeller in vertical flight and FIG. 4B shows a configuration an embodiment of a stacked propeller in cruise configuration. In the operation mode shown by FIG. 4B, the blades 469 of the first propeller 460 and the second propeller 462 can be recessed within the internal cavity 472 of the rotor mast 470 (e.g., a boom) in order to reduce drag. Some or all of the propellers 160 may be recessed in this manner during transition to forward flight, as shown in FIG. 5. FIG. 5 illustrates a configuration of the aircraft 100 during transition and/or forward flight. In FIG. 5, propellers 160 are recessed in their respective booms. In the embodiment of FIG. 5, a hub of each propeller 160a, 160b, 160c, and 160d protrudes from the wing 105 of the aircraft 100. In alternative embodiments, propellers 160 are recessed in a cavity of a boom such that the boom is flush with the wing 105 and/or only slightly protruding from the wing 105 in order to reduce drag. During forward flight, the cruise propellers 150 are rotating to generate thrust. In some configurations, cruise propeller 150a can be rotating in an opposite direction to cruise propeller 150b. The controls surfaces (e.g., control surface 130, rudder 156, tail control surface 157) can return to a neutral position.

As the aircraft 100 transitions to vertical descent, the propellers 160 are redeployed from the boom and the cruise propellers 150 stop rotating. The control surfaces and boom control effectors may be hinged about their respective hinging axis. In some embodiments, the aircraft 100 includes landing gear that is deployed as the aircraft is near landing. The aircraft 100 transitions from the configuration, shown in FIG. 5, to the configuration shown in FIGS. 1A-1B. As such, the aircraft 100 relies on propellers 160 to generate lift for descent.

### ADDITIONAL CONSIDERATIONS

The description has been presented for the purpose of illustration; it is not intended to be exhaustive or to limit the invention to the precise forms disclosed. Persons skilled in the relevant art can appreciate that many modifications and variations are possible in light of the above disclosure.

Aspects of the invention, such as software for implementing the processes described herein, may be embodied in a non-transitory tangible computer readable storage medium or any type of media suitable for storing electronic instructions which may be coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description but rather by any claims that issue on an application based hereon. Accordingly, the disclosure of the embodiments of the invention is intended to be illustrative but not limiting of the scope of the invention.

What is claimed is:

1. An aircraft having a center of gravity, the aircraft comprising:
a fuselage;
a forward swept wing mounted to the fuselage, the wing having a port segment and a starboard segment, each segment extending outwardly from the fuselage to a free end, wherein the free end of each segment is a forward most region of the wing;
a tail region extending from the fuselage; and
a set of propellers configured such that an aerodynamic center is approximately aligned with the center of gravity during a mode of operation, the set including a first propeller, a second propeller, and a third propeller, wherein the first propeller and the second propeller are coupled to the wing, and the third propeller is coupled to the tail region.

2. The aircraft of claim 1, further comprising:
a first wing boom attached along the starboard segment of the wing; and
a second wing boom attached along the port segment of the wing,
wherein the tail region includes a tail boom.

3. The aircraft of claim 2, further comprising:
a third wing boom attached to a free end of the starboard segment of the wing; and
a fourth wing boom attached to a free end of the port segment of the wing.

4. The aircraft of claim 2, wherein at least one of the first wing boom, the second wing boom, or the tail boom includes a boom control effector configured to direct airflow generated by a propeller.

5. The aircraft of claim 2, wherein at least one of the first wing boom, the second wing boom, or the tail boom is hollow and is configured as a resonator tuned to a frequency of a propeller during the mode of operation.

6. The aircraft of claim 2, wherein at least one of the first wing boom, the second wing boom, or the tail boom is configured to retain a battery.

7. The aircraft of claim 2, wherein the first wing boom is attached to an approximate mid-point of the starboard segment of the wing and the second wing boom is attached to an approximate mid-point of the port segment of the wing.

8. The aircraft of claim 2, wherein the first and second propellers are coupled to the first and second wing booms, respectively.

9. The aircraft of claim 8, further comprising
a fourth propeller coupled to a third wing boom, wherein the third wing boom is coupled to the starboard segment of the wing; and
a fifth propeller coupled to a fourth wing boom, wherein the fourth wing boom is coupled to the port segment of the wing.

10. The aircraft of claim 1, further comprising:
a fourth propeller coupled to the tail region of the aircraft, wherein at least one of the first propeller, the second propeller, the third propeller, and the fourth propeller includes a set of co-rotating propellers.

11. The aircraft of claim 1, wherein an angle formed by the starboard segment of the wing and the fuselage is less than 20 degrees.

12. The aircraft of claim 1, further comprising:
a set of cruise propellers coupled to each free end of the wing, wherein each cruise propeller rotates in a plane substantially orthogonal to the wing.

13. The aircraft of claim 1, wherein the first propeller, the second propeller, and the third propeller have substantially equal diameters.

14. The aircraft of claim 1, wherein the first propeller rotates in a direction opposite to a rotational direction of the second propeller during the mode of operation.

15. The aircraft of claim 1, wherein at least one of the first propeller, the second propeller, or the third propeller is configured to recess within an internal cavity of the aircraft during a second mode of operation.

16. The aircraft of claim 1, wherein the tail region includes a T-tail having a fin with a rudder configured to control yaw motion of the aircraft and a tail plane attached perpendicularly to the fin.

17. The aircraft of claim 16, wherein the tail plane includes a tail control surface configured to rotate about an axis parallel to the tail plane to control the pitch of the aircraft.

18. The aircraft of claim 1, wherein a total area of the set of propellers has a disc loading of less than 15 pounds per square foot.

19. The aircraft of claim 1, further comprising four seats, disposed within the fuselage, oriented in two rows, wherein the two rows are tiered such that one row of seats is elevated above the other row of seats.

20. The aircraft of claim 1, wherein the first propeller is attached to a free end of the starboard segment of the wing and the second propeller is attached to a free end of the port segment of the wing.
